(19) United States
(12) Patent Application Publication
(10) Pub. No.: US 2020/0319393 A1
(43) Pub. Date: Oct. 8, 2020

(54) OPTICAL MEMBER, MANUFACTURING METHOD THEREOF AND DISPLAY DEVICE INCLUDING OPTICAL MEMBER

(71) Applicant: Samsung Display Co., LTD., Yongin-si (KR)

(72) Inventors: Mun Sik CHOI, Yongin-Si (KR); Gi Young Kang, Yongin-si (KR); Han Bum Kwon, Yongin-si (KR); Ki Soo Nam, Yongin-si (KR)

(21) Appl. No.: 16/784,178

(22) Filed: Feb. 6, 2020

(30) Foreign Application Priority Data
Apr. 3, 2019 (KR) 10-2019-0039084

(51) Int. Cl. F21V 8/00

(52) U.S. Cl. CPC G02B 6/0055; G02B 6/005

(57) ABSTRACT

An optical member including a light guide plate including an upper surface, a lower surface facing the upper surface, a first side surface disposed between the upper surface and the lower surface, a first inclined surface disposed between the upper surface and the first side surface, and a second inclined surface disposed between the lower surface and the first side surface, and a first reflective member including a first side portion covering the first side surface, a first folded portion extending from the first side portion to one side thereof and covering the first inclined surface, and a second folded portion extending from the first side portion to the other side thereof and covering the second inclined surface, in which the first reflective member includes a reflective layer having at least one curved surface.

### CROSS-REFERENCE TO RELATED APPLICATION

This application claims priority to and the benefit of Korean Patent Application No. 10-2019-0039084, filed on Apr. 3, 2019, which is hereby incorporated by reference for all purposes as if fully set forth herein.

### BACKGROUND

### Field

Exemplary embodiments of the invention relate generally to an optical member, a manufacturing method thereof, and a display device including the optical member.

### Discussion of the Background

A liquid crystal display receives light from a backlight assembly and displays an image. Some backlight assemblies include a light source and a light guide plate. The light guide plate receives light from the light source, and guides light to travel toward the display panel. Some backlight assemblies use white light provided as the light source, and the white light is filtered by a color filter on the display panel to implement color.

Recently, application of a wavelength conversion film has been studied to improve an image quality, such as color reproducibility, of a liquid crystal display. A blue light source is usually used as a light source, and a wavelength conversion film is disposed on the upper side of the light guide plate to convert blue light into white light. However, when light emitted from the blue light source leaks to the side of the light guide plate, it may be recognized as light leakage to a user.

The above information disclosed in this Background section is only for understanding of the background of the inventive concepts, and, therefore, it may contain information that does not constitute prior art.

### SUMMARY

An optical member constructed according to exemplary embodiments of the invention and a display device including the same are capable of preventing leakage of incident light and a manufacturing method thereof.

Additional features of the inventive concepts will be set forth in the description which follows, and in part will be apparent from the description, or may be learned by practice of the inventive concepts.

An optical member according to an exemplary embodiment includes a light guide plate including an upper surface, a lower surface facing the upper surface, a first side surface disposed between the upper surface and the lower surface, a first inclined surface disposed between the upper surface and the first side surface, and a second inclined surface disposed between the lower surface and the first side surface, and a first reflective member including a first side portion covering the first side surface, a first folded portion extending from the first side portion to one side thereof and covering the first inclined surface, and a second folded portion extending from the first side portion to the other side thereof and covering the second inclined surface, in which the first reflective member includes a reflective layer having at least one curved surface.

The optical member may further include a wavelength conversion layer having a first refractive index and disposed on the upper surface of the light guide plate, and a low refractive index layer having a second refractive index and disposed between the light guide plate and the wavelength conversion layer, in which the light guide plate may have a third refractive index greater than each of the first and second refractive indices.

The first reflective member may further includes a substrate layer, the reflective layer may be disposed between the first side surface of the light guide plate and the substrate layer, and the reflective layer may include at least one of silver (Ag), copper (Cu), gold (Au), and aluminum (Al).

A width of the first side portion of the first reflective member may be greater than a width of each of the first folded portion and the second folded portion.

An area of the first folded portion may be substantially the same as an area of the first inclined surface of the light guide plate, and an area of the second folded portion may be substantially the same as an area of the second inclined surface of the light guide plate.

The first folded portion or the second folded portion further may include a light absorbing layer disposed between the light guide plate and the reflective layer.

The optical member may further include a second reflective member, in which the light guide plate may further include a second side surface adjacent to the first side surface, a third inclined surface disposed between the upper surface and the second side surface, and a fourth inclined surface disposed between the lower surface and the second side surface, and the second reflective member may include a second side portion covering the second side surface, a third folded portion extending from the second side portion to one side thereof and covering the third inclined surface, and a fourth folded portion extending from the second side portion to the other side thereof and covering the fourth inclined surface.

The optical member may further include a third reflective member, in which the light guide plate may further include a third side surface adjacent to the first side surface and opposite to the second side surface, a fifth inclined surface disposed between the upper surface and the third side surface, and a sixth inclined surface disposed between the lower surface and the third side surface, and the third reflective member may include a third side portion covering the third side surface, a fifth folded portion extending from the third side portion to one side thereof and covering the fifth inclined surface, and a sixth folded portion extending from the third side portion to the other side thereof and covering the sixth inclined surface.

A display device according to another exemplary embodiment includes a light guide plate including an upper surface, a lower surface facing the upper surface, a first side surface disposed between the upper surface and the lower surface, a second side surface facing the first side surface, a first inclined surface disposed between the upper surface and the first side surface, and a second inclined surface disposed between the lower surface and the first side surface, a light source disposed to face the second side surface of the light guide plate and configured to emit light of a first color, a reflective member including a first side portion covering the first side surface, and a first folded portion extending from the first side portion to one side thereof and covering the first inclined surface, and a display panel disposed on the light guide plate, in which the reflective member includes a reflective layer having at least one curved surface.

The display device may further include a wavelength conversion layer disposed on the upper surface of the light guide plate, in which the wavelength conversion layer may include a first wavelength conversion material and a second wavelength conversion material, the first wavelength conversion material may convert light of the first color into light of a second color different from the first color, and the second wavelength conversion material may convert light of the first color into light of a third color different from the first color and the second color.

The first color may be blue, the second color may be red, and the third color may be green, and the light guide plate may be configured to emit white light toward the display panel.

A manufacturing method of an optical member according to still another exemplary embodiment includes the steps of preparing a light guide plate including an upper surface, a lower surface facing the upper surface, a side surface disposed between the upper surface and the lower surface, a first inclined surface disposed between the upper surface and the side surface, and a second inclined surface disposed between the lower surface and the side surface, disposing a reflective member including a reflective layer on one side of the light guide plate, and attaching the reflective member on the side surface, the first inclined surface, and the second inclined surface of the light guide plate using a heat pressing apparatus.

The steps may further include forming a wavelength conversion layer including a quantum dot on the upper surface of the light guide plate.

The step of attaching the reflective member may include heating the heat pressing apparatus to a first temperature, and pressing the reflective member using the heat pressing apparatus.

The first temperature may be in a range of about 30° C. to about 50° C.

An acute angle formed by the first inclined surface or the second inclined surface with the side surface may range from about 30 degrees to about 60 degrees.

The reflective member may include a side portion, a first folded portion extending from the side portion to one side thereof, and a second folded portion extending from the side portion to the other side thereof, and the side portion may be substantially parallel to the side surface of the light guide plate.

The heat pressing apparatus may include a first heat pressing portion, a second heat pressing portion extending from the first heat pressing portion to one side thereof, and a third heat pressing portion extending from the first heat pressing portion to the other side thereof, and the first heat pressing portion may be substantially parallel to the side surface of the light guide plate.

An area of the first heat pressing portion may be substantially the same as an area of the side surface of the light guide plate, an area of the second heat pressing portion may be substantially the same as or greater than an area of the first inclined surface of the light guide plate, and an area of the third heat pressing portion may be substantially the same as or greater than an area of the second inclined surface of the light guide plate.

An acute angle formed by the second heat pressing portion and the first heat pressing portion may be substantially the same as an acute angle formed by the side surface of the light guide plate and the first inclined surface, and an acute angle formed by the third heat pressing portion and the first heat pressing portion may be substantially the same as an acute angle formed by the side surface of the light guide plate and the second inclined surface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view of an optical member and a light source according to an exemplary embodiment.

FIG. 2 is a cross-sectional view taken along line II-II′ of FIG. 1.

FIG. 3 is an enlarged view of region Q of FIG. 2.

FIG. 4 is a plan view of a reflective member according to an exemplary embodiment.

FIG. 5 is a cross-sectional view taken along line V-V of FIG. 4.

FIG. 6 is a perspective view of an optical member according to another exemplary embodiment.

FIG. 7 is a cross-sectional view taken along line VII-VII′ of FIG. 6.

FIG. 8 is a plan view of a reflective member according to another exemplary embodiment.

FIG. 9 is a cross-sectional view taken along line IX-IX′ of FIG. 8.

FIG. 10 is a cross-sectional view of a display device according to an exemplary embodiment.

FIG. 11 is a flowchart showing a manufacturing method of an optical member according to an exemplary embodiment.

FIGS. 12, 13, and 14 are schematic cross-sectional views that sequentially illustrate the manufacturing method of an optical member according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

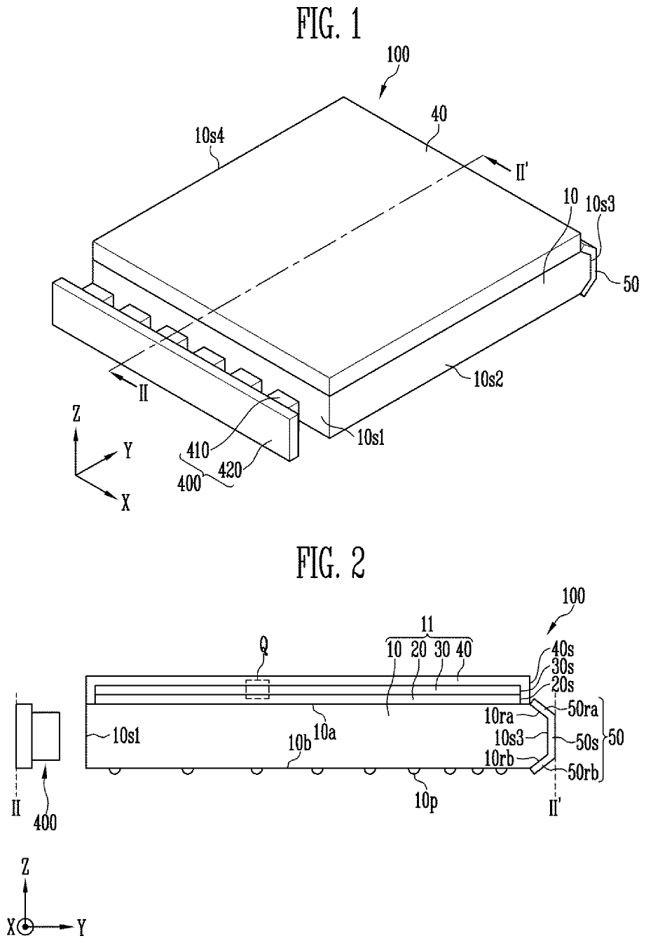

FIG. 1 is a perspective view of an optical member and a light source according to an exemplary embodiment. FIG. 2 is a cross-sectional view taken along line of FIG. 1.

Referring to FIGS. 1 and 2, the optical member 100 includes a light guide plate 10, a low refractive index layer 20 disposed on the light guide plate 10, a wavelength conversion layer 30 disposed on the low refractive index layer 20, a passivation layer 40 disposed on the wavelength conversion layer 30, and a reflective member 50. The light guide plate 10, the low refractive index layer 20, the wavelength conversion layer 30, and the passivation layer 40 may be formed integrally as a stacking structure body 11. In particular, the optical member 100 may include a stacking structure body 11 and a reflective member 50. The reflective member 50 may cover one side surface of the light guide plate 10. In this case, an upper surface of the stacking structure body 11 may be an upper surface of the passivation layer 40, and a lower surface of the stacking structure body 11 may be a lower surface 10b of the light guide plate 10. The stacking structure body 11 may further include a scattering pattern 10p disposed on the lower surface 10b of the light guide plate 10.

The light guide plate 10 may guide a path of light. The light guide plate 10 may have a generally polygonal columnar shape. A planar shape of the light guide plate 10 may be a substantially rectangular shape, but is not limited thereto. In an exemplary embodiment, the planar shape of the light guide plate 10 may be a substantially rectangular shape and the light guide plate 10 may include an upper surface 10a, a lower surface 10b, and four side surfaces 10s1, 10s2, 10s3, and 10s4.

In an exemplary embodiment, each of the upper surface 10a and the lower surface 10b of the light guide plate 10 is respectively disposed on one plane, and a plane on which the upper surface 10a is disposed and a plane on which the lower surface 10b is disposed are substantially parallel to each other, so that the light guide plate 10 may have a uniform thickness as a whole. However, the inventive concepts are not limited thereto, and in some exemplary embodiments, the upper surface 10a or the lower surface 10b may have a plurality of planes, or a plane on which the upper surface 10a is disposed and a plane on which the lower surface 10b is disposed may intersect with each other. For example, a thickness of the light guide plate 10 may become thinner from one side surface (e.g., a light incidence surface) to the other side surface (e.g., a light facing surface) opposite thereto, such as a wedge-shaped light guide plate. As another example, the thickness of the light guide plate 10 may become thinner from one side surface (e.g., a light incidence surface) to a specific point towards the other side surface (e.g., a light facing surface) opposite thereto with the lower surface 10b inclining upward, and then the upper surface and the lower surface 10b may be formed in a flat shape.

As shown in FIG. 2, the light guide plate 10 may include inclined surfaces 10ra and 10rb between the upper surface 10a and the one side surface 10s3 and between the lower surface 10b and the one side surface 10s3. In particular, the light guide plate 10 may include a chamfer formed by cutting an angular corner. The chamfer may mitigate the sharpness in the corner of the light guide plate 10 to prevent a damage from an external impact.

When the inclined surfaces 10ra and 10rb of the light guide plate 10 are planar, the inclined surfaces 10ra and 10rb may form an angle with one side surface 10s3 of the light guide plate 10. Hereinafter, an angle formed by two surfaces may mean an angle between two planes including two surfaces, respectively, and may include an acute angle and an obtuse angle.

An acute angle formed by one side surface 10s3 of the light guide plate 10 and a first inclined surface 10ra may be about 30 to about 60 degrees, and an acute angle formed by one side surface 10s3 and a second inclined surface 10rb may be also be about 30 to about 60 degrees.

The acute angle formed by one side surface 10s3 and the first inclined surface 10ra may be substantially the same as the acute angle formed by one side surface 10s3 and the second inclined surface 10rb, without being limited thereto.

The inclined surfaces 10ra and 10rb may be planar as shown in FIGS. 1 and 2, however, the inventive concepts are not limited thereto. In some exemplary embodiments, at least one of the inclined surfaces 10ra and 10rb may be curved.

FIG. 2 illustrate a structure including the inclined surfaces 10ra and 10rb between the upper surface 10a and the one side surface 10s3 of the light guide plate 10 and between the lower surface 10b and the one side surface 10s3 of the light guide plate 10, however, the inventive concepts are not limited thereto. For example, in some exemplary embodiments, the inclined surfaces 10ra or 10rb may be formed either between the upper surface 10a and the one side surface 10s3 of the light guide plate 10 or between the lower surface 10b and the one side surface 10s3 of the light guide plate 10. As another example, the light guide plate 10 may include an inclined surface between the other side surfaces 10s1, 10s2, and 10s4 of the light guide plate 10 and the upper surface 10a and the lower surface 10b.

According to an exemplary embodiment, a light source 400 may be disposed adjacent to at least one side surface 10s1, 10s2, 10s3, and 10s4 of the light guide plate 10. FIG. 1 shows a plurality of LED light sources 410 mounted on a flexible printed circuit 420 and disposed adjacent to one side surface 10s1 of the light guide plate 10, however, the inventive concepts are not limited thereto. For example, in some exemplary embodiments, a plurality of LED light sources 410 may be disposed adjacent to opposite side surfaces 10s1 and 10s3. According to the illustrated exemplary embodiment, the side surface 10s1 of one long side of the light guide plate 10 adjacent to the light source 400 is a light incidence surface 10s1, to which light of the light source 400 is directly incident, and the side surface 10s3 of the other long side opposite thereto is a light-facing surface 10s3.

The LED light source 410 may emit blue light. More particularly, light emitted from the LED light source 410 may be light having a blue wavelength band. In an exemplary embodiment, a wavelength band of the blue light emitted from the LED light source 410 may be about 400 nm to about 500 nm. The blue light emitted from the LED light source 410 may be incident into the light guide plate 10 through the light incidence surface 10s1.

The light guide plate 10 may include inorganic material. For example, the light guide plate 10 may be made of glass, without being limited thereto.

On the upper surface 10a of the light guide plate 10, the low refractive index layer 20 is disposed. The low refractive index layer 20 may be formed directly on the upper surface 10a of the light guide plate 10 to contact the upper surface 10a of the light guide plate 10. The low refractive index layer 20 is interposed between the light guide plate 10 and the wavelength conversion layer 30 to allow total reflection of the light guide plate 10.

In order to efficiently guide light from the light incidence surface 10s1 to the light facing surface 10s3 by the light guide plate 10, an internal total reflection may need to be effectively achieved on the upper surface 10a and the lower surface 10b of the light guide plate 10. One of conditions under which the internal total reflection may be achieved in the light guide plate 10 is that a refractive index of the light guide plate 10 is greater than a refractive index of a medium forming an optical interface with the light guide plate 10. As the refractive index of the medium forming the optical interface with the light guide plate 10 is lower, a critical angle of the total reflection may become smaller, and thus, more internal total reflection may be achieved.

The low refractive index layer 20 interposed between the light guide plate 10 and the wavelength conversion layer 30, and forming an interface with the upper surface 10a of the light guide plate 10 has a refractive index lower than the light guide plate 10, so that the total reflection is achieved on the upper surface 10a of the light guide plate 10. In addition, the low refractive index layer 20 has a refractive index lower than the wavelength conversion layer 30, which is a material layer disposed on top of the low refractive index layer 20, thereby achieving more total reflection than when the wavelength conversion layer 30 is directly disposed on the upper surface 10a of the light guide plate 10.

A difference between the refractive index of the light guide plate 10 and the refractive index of the low refractive index layer 20 may be about 0.2 or more. When the refractive index of the low refractive index layer 20 is smaller than the refractive index of the light guide plate 10 by about 0.2 or more, a sufficient total reflection may be achieved through the upper surface 10a of the light guide plate 10. An upper limit of the difference between the refractive index of the light guide plate 10 and the refractive index of the low refractive index layer 20 is not particularly limited, but may be about 1 or less in consideration of the material of the generally-used light guide plate 10 and the refractive index of the low refractive index layer 20.

The refractive index of the low refractive index layer 20 may be in the range of about 1.2 to about 1.4. Generally, as the refractive index of a solid medium becomes closer to 1, a manufacturing cost increases significantly. When the refractive index of the low refractive index layer 20 is about 1.2 or more, an abrupt increase in the manufacturing cost may be prevented. In addition, the refractive index of the low refractive index layer 20 is about 1.4 or less, a critical angle of the total reflection of the upper surface 10a of the light guide plate 10 may be sufficiently reduced. In an exemplary embodiment, a low refractive index layer 20 may have a refractive index of about 1.25.

The low refractive index layer 20 may include a void to exhibit a low refractive index described above. The void may be formed of vacuum, or may be filled with an air layer, gas, or the like. A space of the void may be defined by a particle or a matrix.

A thickness of the low refractive index layer 20 may be about 0.4 μm to about 2 μm. When the thickness of the low refractive index layer 20 is about 0.4 μm or more, which is a wavelength range of visible light, the low refractive index layer 20 may form an effective optical interface with the upper surface 10a of the light guide plate 10, so that the total reflection according to the Snell's law may be facilitated on the upper surface 10a of the light guide plate 10. When the low refractive index layer 20 is too thick, the low refractive index layer 20 may be formed with a thickness of 2 μm or less because a thinning of the optical member 100 is not performed, a cost of materials increases, and a luminance of the optical member 100 is disadvantageous.

In an exemplary embodiment, the low refractive index layer 20 covers most of the upper surface 10a of the light guide plate 10 while exposing an edge of the upper surface 10a of the light guide plate 10. The portion of the upper surface 10a exposed by low refractive index layer 20 may provide space for the side surface 20s of the low refractive index layer 20 to be stably covered by a passivation layer 40.

In another exemplary embodiment, due to a manufacturing process of the light guide plate 10, the low refractive index layer 20 may cover the entire upper surface 10a of the light guide plate 10. In this case, the side surface of the low refractive index layer 20 may be aligned at each side surface of the light guide plate 10.

The low refractive index layer 20 may be formed by coating or the like. For example, a composition for a low refractive index layer may be coated on the upper surface 10a of a light guide plate 10, followed by drying and curing processes to form the low refractive index layer 20. A coating method of the composition for the low refractive index layer may include a slit coating, a spin coating, a roll coating, a spray coating, an ink jet, and the like, but the inventive concepts are not limited thereto, and various stacking methods may be applied.

According to an exemplary embodiment, a barrier layer may be further disposed between the low refractive index layer 20 and the light guide plate 10. The barrier layer may cover the entire upper surface 10a of the light guide plate 10. The side surface of the barrier layer may be aligned to the side surface 10s of the light guide plate 10. The low refractive index layer 20 is formed in contact with the upper surface of the barrier layer. In this case, the low refractive index layer 20 may expose a portion of edges of the barrier layer.

The barrier layer prevents penetration of moisture and oxygen. The barrier layer may be formed of an inorganic material. For example, the barrier layer may include at least one of silicon nitride, aluminum nitride, zirconium nitride, titanium nitride, hafnium nitride, tantalum nitride, silicon oxide, aluminum oxide, titanium oxide, tin oxide, cerium oxide, silicon oxynitride, or a metal thin film having a light transmittance secured, or the like. The barrier layer may be formed by chemical vapor deposition, without being limited thereto.

On an upper surface of the low refractive index layer 20, the wavelength conversion layer 30 is disposed. The wavelength conversion layer 30 converts a wavelength of at least a portion of light incident thereon. The wavelength conversion layer 30 may include a binder layer and a wavelength conversion particle dispersed in the binder layer. The wavelength conversion layer 30 may further include scattering particles dispersed in the binder layer in addition to the wavelength conversion particle.

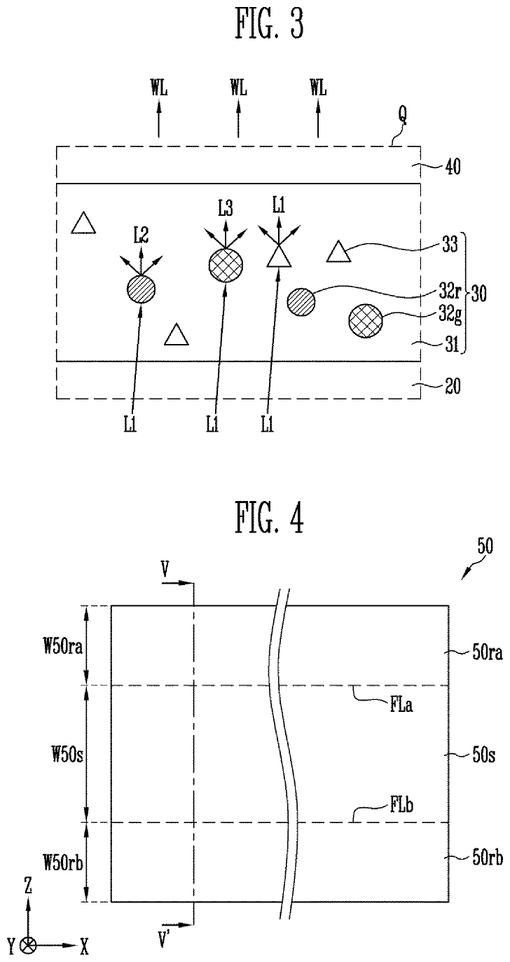

Hereinafter, a structure of the wavelength conversion layer 30 will be described in detail with reference to FIG. 3.

FIG. 3 is an enlarged view of a region Q of FIG. 2.

Referring to FIG. 3, the binder layer 31 may be a medium in which the wavelength conversion particles 32r and 32g are dispersed, and may be formed of various resin compositions that may be generally referred to as a binder. However, the inventive concepts are not limited thereto, and as used herein, any medium capable of dispersing the wavelength conversion particles 32r and 32g and/or scattering particles 33 may be referred to as the binder layer 31 regardless of a name thereof, additional other functions, constituent materials, and the like.

The wavelength conversion particles 32r and 32g are particles that convert a wavelength of incident light, for example, a quantum dot (QD), a phosphor material, or a phosphorescent material. Hereinafter, the wavelength conversion particles 32r and 32g will be described as quantum dots. However, the inventive concepts are not limited thereto.

The quantum dot is a material having a crystal structure of several nanometers in size, consisting of hundreds to thousands of atoms, exhibiting a quantum confinement effect with an energy band gap increased due to its small size. When light having a wavelength higher than the band gap is incident on the quantum dot, the quantum dot is excited by absorbing the light and falls to a ground state while emitting light of a specific wavelength. The emitted light has a value corresponding to the band gap. The quantum dots may control a light emitting characteristic by the quantum confinement effect by adjusting the size and composition thereof.

Semiconductor nanocrystals of the quantum dots may include IV-group nano crystals, II-VI group compound nano crystals, III-V group compound nano crystals, and IV-VI group nano crystals, or combinations thereof.

For example, the IV-group nano crystals may include two-element compounds, such as silicon (Si), germanium (Ge), silicon carbide (SiC), and silicon-germanium (SiGe), and the like, without being limited thereto.

In addition, the II-VI group compound nano crystals may include two-element compounds, such as CdSe, CdTe, ZnS, ZnSe, ZnTe, ZnO, HgS, HgSe, HgTe, MgSe, MgS, and mixtures thereof, three-element compounds, such as CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and mixtures thereof, or four-element compounds, such as HgZnTeS, CdZnSeS, CdZnSeTe, CdZnSTe, CdHgSeS, CdHgSeTe, CdHgSTe, HgZnSeS, HgZnSeTe, HgZnSTe, and mixtures thereof, without being limited thereto.

In addition, the III-V group compound nano-crystals may include two-element compounds, such as GaN, GaP, GaAs, GaSb, AlN, AlP, AlAs, AlSb, InN, InP, InAs, InSb, and mixtures thereof, three-element compounds, such as GaNP, GaNAs, GaNSb, GaPAs, GaPSb, AlNP, AlNAs, AlNSb, AlPAs, AlPSb, InGaP, InNP, InNAs, InNSb, InPAs, InPSb, and mixtures thereof, or four-element compounds, such as GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and mixtures thereof, without being limited thereto.

The IV-VI group nano crystals may include two-element compounds, such as SnS, SnSe, SnTe, PbS, Pb Se, PbSe, PbTe, and mixtures thereof, three-element compounds, such as SnSeS, SnSeTe, SnSTe, PbSeS, PbSeTe, PbSTe, SnPbS, SnPbSe, SnPbTe, and mixtures thereof, or four-element compounds, such as SnPbSeTe, SnPbSeTe, SnPbSTe, and mixtures thereof, without being limited thereto.

A shape of the quantum dot is not particularly limited, and may be, for example, spherical, pyramidal, multi-arm or cubic nano particles, nanotube, nano wire, nano fiber, nano plate particles and the like. The two-element compound, the three-element compound, or the four-element compound may exist in the same particle with a uniform concentration, or may exist in the same particle with a concentration distribution being divided into partially different states.

The quantum dot may have a core-shell structure including a core including the nano crystal described above and a shell surrounding the core. An interface between the core and the shell may have a concentration gradient, in which a concentration of an element in the shell decreases toward the center of the quantum dot. The shell of the quantum dot may serve as a protective layer for maintaining a semiconductor characteristic by preventing a chemical denaturation of the core and/or a charging layer for imparting an electrophoretic characteristic to the quantum dot. The shell can be a single layer or multiple layer. The shell of a quantum dot may include a oxide of metal or non-metal, a semiconductor compound or a combination thereof.

For example, the oxide of the metal or non-metal may include two element compound, such as SiO₂, Al₂O₃, TiO₂, ZnO, MnO, Mn₂O₃, Mn₃O₄, CuO, FeO, Fe₂O₃, Fe₃O₄, CoO, Co₃O₄, NiO, or three element compound, such as MgAl₂O₄, CoFe₂O₄, NiFe₂O₄, and CoMn₂O₄, without being limited thereto.

In addition, the semiconductor compound may include CdS, CdSe, CdTe, ZnS, ZnSe, ZnTe, ZnSeS, GaAs, GaP, GaSb, HgS, HgSe, HgTe, InAs, InP, InSb, AlAs, AlP, and the like, without being limited thereto.

The wavelength conversion particles 32r and 32g may include a plurality of wavelength conversion particles 32r and 32g, which convert a wavelength of the incident light to different wavelengths. For example, the wavelength conversion particles 32r and 32g may include a first wavelength conversion particle 32r, which converts a specific wavelength of incident light to emit a first emitted light having a first wavelength, and a second wavelength conversion particle 32g, which converts a specific wavelength of incident light to emit a second emitted light having a second wavelength. In an exemplary embodiment, light emitted from the light source 400 and incident on the wavelength conversion particles 32r and 32g may be blue light L1, the first emitted light may be green light, and the second emitted light may be red light. For example, the blue light may have a peak at about 420 nm to about 470 nm, the green light may have a peak at about 520 nm to about 570 nm, and the red light may have a peak at about 620 nm to about 670 nm. However, the wavelengths of blue light, green light, and red light are not limited thereto and may include all wavelength ranges that can be recognized as blue, green, and red.

In an exemplary embodiment, when light L1 of the blue wavelength incident on the wavelength conversion layer 30 passes through the wavelength conversion layer 30, a first portion of light L1 may be incident on the first wavelength conversion particle 32r to be converted into a red wavelength and emitted, a second portion of light L1 may be incident on the second wavelength conversion particle 32g to be converted into a green wavelength and emitted, and the remaining portion of light L1 may be emitted without being incident on the first and second wavelength conversion particle 32r and 32g. In this manner, light passing through the wavelength conversion layer 30 may include light L1 of the blue wavelength, light L2 of the red wavelength, and light L3 of the green wavelength. By appropriately adjusting a ratio of the emitted light having different wavelengths, it is possible to emit white light WL or emit light having a different color.

The light emitted by the wavelength conversion particles 32r and 32g may have a full width of half maximum (FWHM) of about 45 nm or less, which improves a color purity and color reproducibility of a display device. In addition, light emitted by the wavelength conversion particles 32r and 32g may be emitted toward various directions regardless of an incident direction of light. In this manner, a lateral visibility of the display device may be improved.

According to another exemplary embodiment, when the incident light is light having a single wavelength, such as ultraviolet and the like, the wavelength conversion layer 30 may include three kinds of wavelength conversion particles to convert light into blue, red, and green wavelengths to emit white light.

The wavelength conversion layer 30 may further include a scattering particle 33. The scattering particle 33 is a non-quantum particle, which may be a particle without the wavelength conversion function. The scattering particle 33 scatters the incident light so that more light may be incident on the wavelength conversion particles 32r and 32g. In addition, the scattering particle 33 may control an emission angle of light for each wavelength uniformly. More specifically, when a portion of the incident light is incident on the wavelength conversion particles 32r and 32g and then the wavelength thereof is converted and emitted, an emission direction thereof may have a random scattering characteristic. If there is no scattering particle 33 in the wavelength conversion layer 30, light of the red and green wavelengths L2 and L3 emitted after collision with the wavelength conversion particle 32r and 32g have a scattering emission characteristic, but light of the blue wavelength emitted without collision with the wavelength converting particles does not have a scattering emission characteristic. As such an emission amount of light L1 having the blue wavelength may be different depending on an emission angle. The scattering particle 33 according to an exemplary embodiment may provide the scattering emission characteristic to light having the blue wavelength, such that the emission angle of light having different wavelengths may be substantially similar to each other. The scattering particle 33 may include TiO₂, SiO₂, or the like.

Referring back to FIGS. 1 and 2, the wavelength conversion layer 30 may be thicker than the low refractive index layer 20. The thickness of the wavelength conversion layer 30 may be about 10 μm to about 50 In an exemplary embodiment, the thickness of the wavelength conversion layer 30 may be about 15 μm.

The wavelength conversion layer 30 may cover a upper surface of the low refractive index layer 20 and completely overlap with the low refractive index layer 20. A lower surface 30b of the wavelength conversion layer 30 may directly contact the upper surface of the low refractive index layer 20. In an exemplary embodiment, a side surface 30s of the wavelength conversion layer 30 may be aligned with a side surface 20s of the low refractive index layer 20. The side surface of the wavelength conversion layer 30 may be disposed inside a boundary between the upper surface 10a of the light guide plate 10 and the inclined surface 10r.

FIGS. 1 and 2 show that the side surface 30s of the wavelength conversion layer 30 and the side surface 20s of the low refractive index layer 20 as being vertically aligned on the upper surface 10a of the light guide plate 10, but the inventive concepts are not limited thereto. In some exemplary embodiments, the side surface 30s of the wavelength conversion layer 30 and the side surface 20s of the low refractive index layer 20 may have an inclination angle less than 90 degrees without being perpendicular to the upper surface 10a of the light guide plate 10. In addition, an inclination angle of the side surface 30s of the wavelength conversion layer 30 may be less than an inclination angle of the side surface 20s of the low refractive index layer 20. When the wavelength conversion layer 30 is formed by a slit coating or the like, the side surface 30s of wavelength conversion layer 30 thicker than the side surface 20s of the low refractive index layer 20 may have a gentle inclination angle than the side surface 20s of the low refractive index layer 20. However, the inventive concepts are not limited thereto. In some exemplary embodiments, according to a forming method, the inclination angle of the side surface 30s of the wavelength conversion layer 30 may be substantially equivalent to or less than the inclination angle of the side surface 20s of the low refractive index layer 20.

The wavelength conversion layer 30 may be formed by coating or the like. For example, the wavelength conversion layer 30 may be formed by slit coating, drying and curing a wavelength conversion composition on the light guide plate 10 with the low refractive index layer 20. However, the inventive concepts are not limited thereto, and various other stacking methods may be applied.

The passivation layer 40 is disposed on the low refractive index layer 20 and the wavelength conversion layer 30. The passivation layer 40 prevents a penetration of moisture and oxygen. The passivation layer 40 may be formed of an inorganic material. For example, the passivation layer 40 may include at least one of silicon nitride, aluminum nitride, zirconium nitride, titanium nitride, hafnium nitride, tantalum nitride, silicon oxide, aluminum oxide, titanium oxide, tin oxide, cerium oxide, silicon oxynitride, or a metal thin film having a light transmittance secured, or the like. In an exemplary embodiment, the passivation layer 40 may be formed of silicon nitride.

The passivation layer 40 may completely cover the low refractive index layer 20 and the wavelength conversion layer 30 at the at least one side surface thereof. In an exemplary embodiment, the passivation layer 40 may completely cover the low refractive index layer 20 and the wavelength conversion layer 30 at all side surfaces thereof, but the inventive concepts are not limited thereto.

The passivation layer 40 completely overlaps with the wavelength conversion layer 30, covers the upper surface of the wavelength conversion layer 30, and extends further outwardly from the upper surface of the wavelength conversion layer 30 to cover the side surface 30s of the wavelength conversion layer 30 and the side surface 20s of the low refractive index layer 20. The passivation layer 40 may contact the upper surface of the wavelength conversion layer 30, the side surface 30s of the wavelength conversion layer 30, and the side surface 20s of the low refractive index layer 20. The passivation layer 40 extends to the upper surface 10a of an edge of the light guide plate 10 exposed by the low refractive index layer 20, so that a portion of an edge of the passivation layer 40 may directly contact the upper surface 10a of the light guide plate 10. In an exemplary embodiment, the side surface 40s of the passivation layer 40 may be aligned to the side surface 10s of the light guide plate 10.

A thickness of the passivation layer 40 may be less than a thickness of the wavelength conversion layer 30, and may be similar to or less than the low refractive index layer 20. The thickness of the passivation layer 40 may be about 0.1 μm to about 2 When the thickness of the passivation layer 40 is about 0.1 μm or more, the passivation layer 40 may prevent the penetration of moisture and oxygen significantly, and when the thickness of the passivation layer 40 is about 0.3 μm or more, the passivation layer 40 may prevent the penetration of moisture and oxygen effectively. The passivation layer 40 having a thickness of about 2 μm or less may be advantageous in terms of thinning and transmittance. In an exemplary embodiment, the thickness of the passivation layer 40 may be about 0.4 μm.

The wavelength conversion layer 30, especially the wavelength conversion particle included therein, is vulnerable to moisture and oxygen. A wavelength conversion film generally includes barrier films laminated on the upper and lower surfaces of the wavelength conversion layer to prevent moisture and oxygen from penetrating, however, since the wavelength conversion layer 30 according to the illustrated exemplary embodiment is directly disposed without a barrier film, a sealing structure for protecting the wavelength conversion layer 30 in place of the barrier film is required. As such, according to an exemplary embodiment, the sealing structure for the wavelength conversion layer 30 may be implemented by the passivation layer 40 and the light guide plate 10.

The passivation layer 40 may be formed by a deposition or the like. For example, the passivation layer 40 may be formed on the light guide plate 10, on which the low refractive index layer 20 and the wavelength conversion layer 30 are sequentially formed, by using a chemical vapor deposition. However, the inventive concepts are not limited thereto, and various other stacking methods may be applied.

As described above, the optical member 100 may simultaneously perform an optical guide function and a wavelength conversion function as an integrated single member. The integrated single member may simplify an assembly process of the display device. In addition, the low refractive index layer 20 is disposed on the upper surface 10a of the light guide plate 10, so that a total reflection is effectively performed on the upper surface 10a of the light guide plate 10, and it is possible to prevent degradation of the wavelength conversion layer 30 by sealing the low refractive index layer 20 and the wavelength conversion layer 30 using the passivation layer 40 and the like.

A scattering pattern 10p may be disposed on the lower surface 10b of the light guide plate 10. The scattering pattern 10p serves to change an advancing angle of light propagating inside the light guide plate 10 with the total reflection, thereby emitting light to the outside of the light guide plate 10.

In an exemplary embodiment, the scattering pattern 10p may be provided in a separate layer or pattern. For example, the scattering pattern 10p may be formed as a pattern layer including a protrude pattern and/or concave groove pattern formed on the lower surface 10b of the light guide plate 10 or as a printed pattern.

In another exemplary embodiment, the scattering pattern 10p may be formed by the shape of the light guide plate 10 itself. For example, a concave groove may be formed on the lower surface 10b of the light guide plate 10 to function as a scattering pattern 10p.

A disposition density of the scattering pattern 10p may be controlled to be different according to a region of the light guide plate 10. For example, a region adjacent to the light incidence surface 10s1, which has relatively rich in light quantity, may have a relatively smaller disposition density of the scattering pattern 10p, and the dispose density of a region adjacent to the light facing surface 10s3, which has relatively small light quantity, may have a relatively greater disposition density of the scattering pattern 10p.

A reflective member 50 may be disposed on at least one side surface of the light guide plate 10. FIGS. 1 and 2 show that the reflective member 50 is disposed to cover the light facing surface 10s3 that faces the light incidence surface 10s1. The reflective member 50 may cover the light facing surface 10s3 of the light guide plate 10 and inclined surfaces 10ra and 10rb adjacent to the light facing surface 10s3.

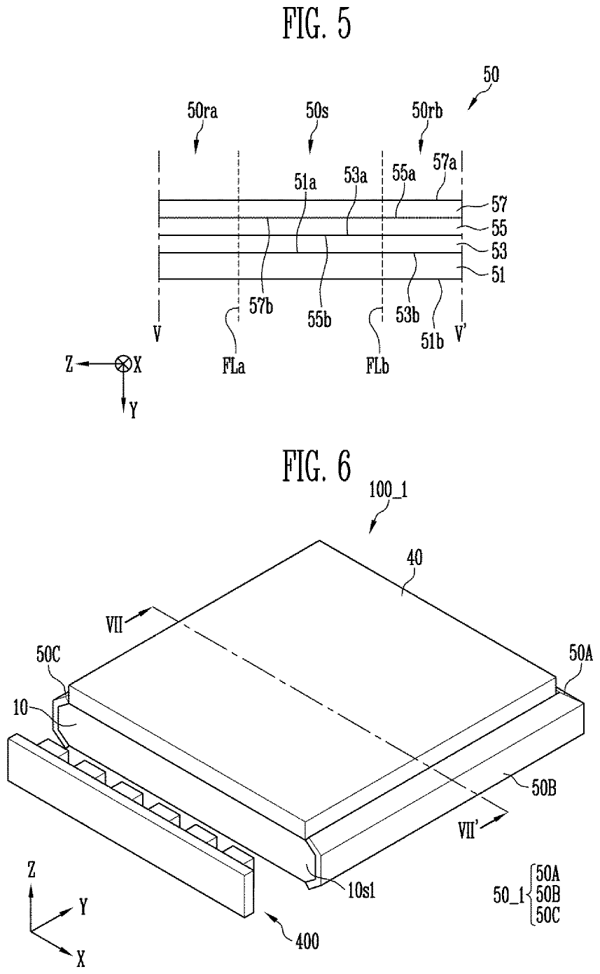

Hereinafter, the reflective member 50 will be described in more detail with reference to FIGS. 4 and 5.

FIG. 4 is a plan view of a reflective member according to an exemplary embodiment. FIG. 5 is a cross-sectional view taken along line V-V′ of FIG. 4.

Referring to FIGS. 4 and 5 with FIGS. 1 and 2, the reflective member 50 may include a first folded portion 50ra, a second folded portion 50rb, and a side facing portion 50s. The side facing portion 50s is a portion facing the side surface of the light guide plate 10. The first folded portion 50ra may be a portion that extends from the side facing portion 50s to one side, and may be folded through a first folded line FLa to cover the first inclined surface 10ra of the light guide plate 10. The second folded portion 50rb may be a portion that extends from the side facing portion 50s to the other side, and may be folded through a second folded line FLb to cover the second inclined surface 10rb of the light guide plate 10. More particularly, the first folded portion 50ra and the second folded portion 50rb of the reflective member 50 may be separated through the side facing portion 50s and the folded lines FLa and FLb.

As described above, when the light guide plate 10 includes the inclined surfaces 10ra and 10rb on the upper or lower side of the light guide plate 10, the reflective member 50 may also include the first folded portion 50ra or the second folded portion 50rb.

The reflective member 50 is disposed on the side surface of the light guide plate 10, thereby preventing light incident into the light guide plate 10 from leaking to the outside. More specifically, referring to FIGS. 1 and 2, light emitted from the light source 400 is incident into the light guide plate 10 through the light incidence surface 10s1 of the light guide plate 10. Light incident into the light guide plate 10 may be guided by the light guide plate 10, and proceed in a direction towards where the wavelength conversion layer 30 is disposed. In this case, some light may leak outside the light guide plate 10 without proceeding in the direction towards where the wavelength conversion layer 30 is disposed. More particularly, light incident on the light facing side 10s3 and on the inclined surfaces 10ra and 10rb of the light guide plate 10 may be largely leaked.

However, since the reflective member 50 according to an exemplary embodiment includes a reflective surface, the reflective member 50 may reflect light incident on the reflective member 50 back to the light guide plate 10. In addition, since the reflective member 50 includes the first folded portion 50ra and the second folded portion 50rb, the reflective member 50 may effectively prevent light from leaking to the first inclined surface 10ra and the second inclined surface 10rb of the light guide plate 10.

A width w50ra of the first folded portion 50ra is substantially the same as a width of the first inclined surface 10ra of the light guide plate 10, so that an area of the first folded portion 50ra may be substantially the same as an area of the first inclined surface 10ra. In addition, a width w50rb of the second folded portion 50rb is substantially the same as a width of the second inclined surface 10rb of the light guide plate 10, so that an area of the second folded portion 50rb may be substantially the same as an area of the second inclined surface 10rb.

The area of the first folded portion 50ra and the second folded portion 50rb may be substantially the same as each other. In addition, the area of each of the first folded portion 50ra and the second folded portion 50rb may be smaller than the area of the side facing portion 50s. For example, the width w50ra of the first folded portion 50ra may be substantially the same as the width w50rb of the second folded portion 50rb, and the width w50s of the side facing portion 50s may be substantially the same as a sum of the width w50ra of the first folded portion 50ra and the width w50rb of the second folded portion 50rb.

However, the areas of the first folded portion 50ra, the second folded portion 50rb, and the side facing portion 50s are not limited thereto, and the width w50ra of the first folded portion 50ra may be larger than the width w50rb of the second folded portion 50rb, or vice versa. In addition, the width w50ra of the first folded portion 50ra or the width w50rb of the second folded portion 50rb may be larger than the width w50s of the side facing portion 50s.

An overall width of the reflective member 50 may be the sum of the widths w50ra and w50ba of the folded portions 50ra and 50ba and the width w50s of the side facing portions 50s. The overall width of the reflective member 50 may be larger than the thickness of the light guide plate 10.

In addition, the first folded portion 50ra and the second folded portion 50rb may be attached along the first inclined surface 10ra and the second inclined surface 10rb, and thus, the first folded portion 50ra and the second folded portion 50rb may have substantially the same shape as the first inclined surface 10ra and the second inclined surface 10rb, respectively.

The reflective member 50 may include a substrate layer 51, a reflective layer 53, a protective layer 55, and an adhesive layer 57.

The substrate layer 51 may be a supporting member that supports each layer of the reflective member 50. An area of the substrate layer 51 may be substantially the same as an area of the reflective member 50. The substrate layer 51 may be generally in the form of a thin film, in which an upper surface 51a and a lower surface 51b of the substrate layer 51 are substantially parallel to each other. In an exemplary embodiment, the substrate layer 51 may be a polyethylene terephthalate (PET) film. However, the material of the substrate layer 51 is not particularly limited as long as it is flexible and capable of preventing a penetration of moisture and oxygen.

The reflective layer 53 may be disposed on the upper surface 51a of the substrate layer 51, and a lower surface 53b of the reflective layer 53 may contact the upper surface 51a of the substrate layer 51. The reflective layer 53 may be formed to cover substantially the overall surface of the substrate layer 51. For example, the reflective layer 53 may be formed on the overall surface of the reflective member 50 including the first folded portion 50ra, the second folded portion 50rb, and the side facing portion 50s of the reflective member 50. The upper surface 53a of the reflective layer 53 may be uniformly formed as a whole to be substantially parallel to the upper surface 51a of the substrate layer 51. The reflective layer 53 may have a characteristic of reflecting light incident on the reflective member 50. For example, the reflective layer 53 may have a reflectance of about 80% or more, and may reflect most of light in visible wavelength bands.

In an exemplary embodiment, the reflective layer 53 may include metal having a high reflectivity. For example, the reflective layer 53 may include at least one of silver (Ag), copper (Cu), gold (Au), and aluminum (Al), without being limited thereto.

In another exemplary embodiment, the reflective layer 53 may have a structure in which a plurality of layers having different refractive indices are stacked, such as a reflective polarizing film. The reflective layer 53 may be directly deposited or coated on the upper surface 51a of the substrate layer 51. In still another exemplary embodiment, a separate member including the reflective layer 53 may be attached to the substrate layer 51.

The protective layer 55 may be disposed on the upper surface 53a of the reflective layer 53, and a lower surface 55b of the protective layer 55 may contact the upper surface 53a of the reflective layer 53. In addition, the protective layer 55 may be disposed on the reflective layer 53.

The protective layer 55 may be disposed on the reflective layer 53 to block the penetration of moisture and oxygen into the reflective layer 53. The material of the protective layer 55 is not particularly limited as long as it is flexible, capable of preventing a penetration of moisture and oxygen, and capable of transmitting light.

On the upper surface 55a of the protective layer 55, the adhesive layer 57 may be disposed. The adhesive layer 57 may be a layer that directly contacts the light guide plate 10 when the reflective member 50 is attached to the light guide plate 10. More particularly, an upper surface 57a of the adhesive layer 57 may contact the light facing surface 10s3 and the inclined surfaces 10ra and 10rb of the light guide plate 10, and a lower surface 57b of the adhesive layer 57 may contact the protective layer 55 of the reflective member 50.

The material of the adhesive layer 57 is not particularly limited, as long as it provides adhesiveness when heated, being transparent, and capable of transmitting light.

As described above, the reflective member 50 may have a structure in which the substrate layer 51, the reflective layer 53, the protective layer 55, and the adhesive layer 57 are sequentially stacked. More particularly, the upper surface of the reflective member 50 may be the upper surface 57a of the adhesive layer 57, and the lower surface of the reflective member 50 may be the lower surface 51b of the substrate layer 51. Since the lower surface 51b of the substrate layer 51 may be a layer exposed to the outside, a separate protective layer may be further disposed on the lower surface 51b of the substrate layer 51 to protect the reflective member 50.

The reflective member 50 may be attached on the light facing surface 10s3 of the light guide plate 10 by various methods known in the art. For example, the reflective member 50 may be mechanically attached by using a process equipment, or may be cut to fit in an area of the light facing surface 10s3 and attached by hand.

However, when the reflective member 50 is attached by hand, the reflective member 50 may be unevenly attached onto the light facing surface 10s3 of the light guide plate 10. When the reflective member 50 is attached unevenly, a light reflection efficiency of the reflective member 50 may be reduced and a light leakage may occur to the outside through a gap between the reflective member 50 and the light guide plate 10. In addition, when attached by hand, an attaching time of the reflective member 50 may become long, which may reduce process efficiency.

Accordingly, according to an exemplary embodiment, the reflective member 50 may be mechanically attached onto the light guide plate 10 by using a process equipment to increase display efficiency and the process efficiency of the display device. An attaching method of the reflective member 50 using a process equipment may be, for example, a hot stamping method using a heat pressuring apparatus.

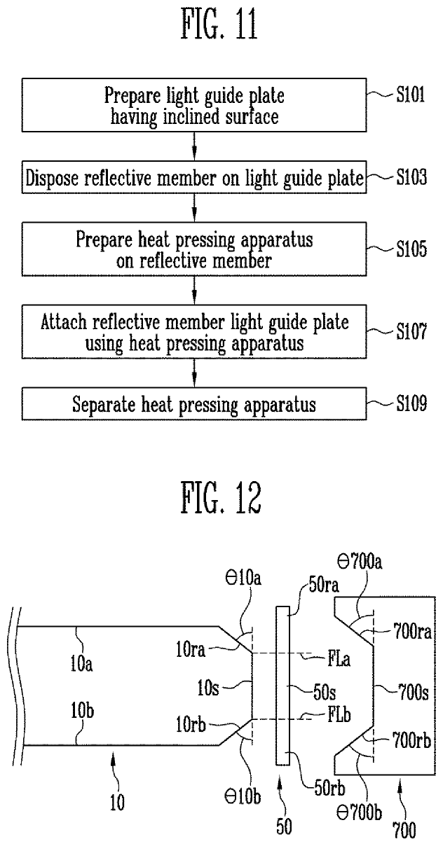

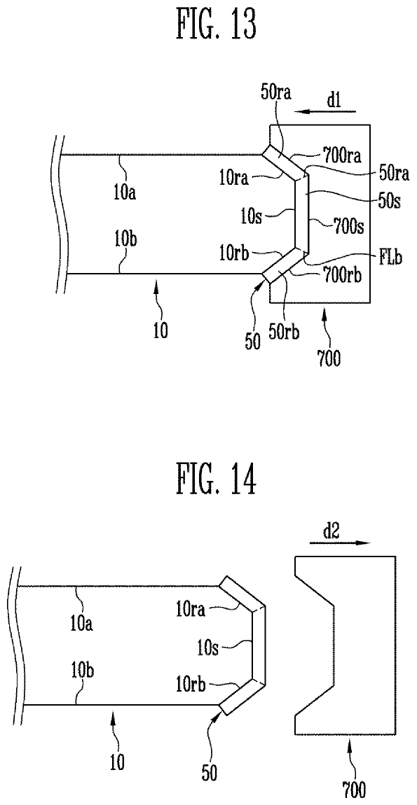

The attaching method of the reflective member by hot stamping will be described later in detail with reference to FIGS. 11 to 14.

Hereinafter, an optical member according to another exemplary embodiment will be described. In the following exemplary embodiments, substantially the same components as those of the optical member described above are denoted by the same reference numerals, and thus, repeated descriptions thereof will be omitted or simplified.

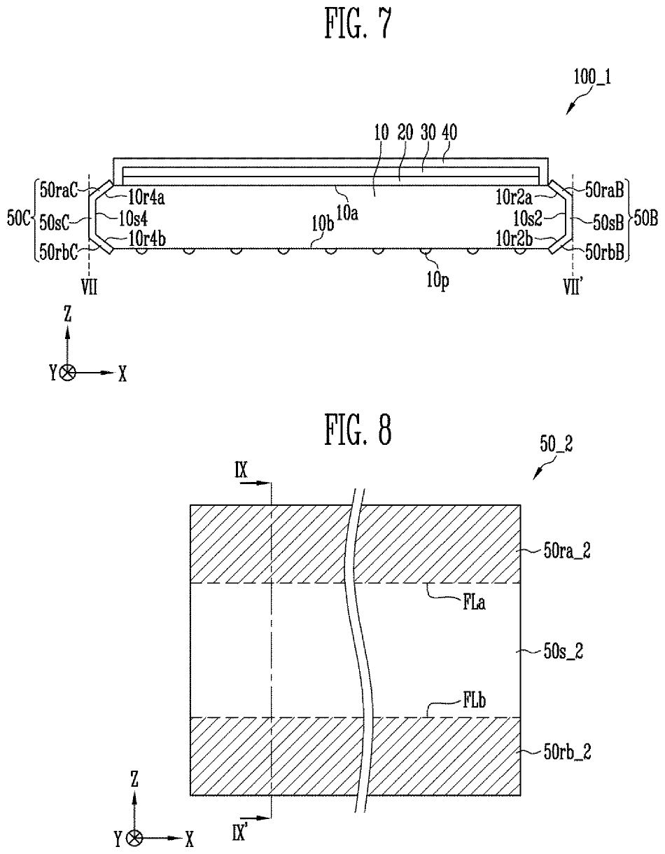

FIG. 6 is a perspective view of an optical member according to another exemplary embodiment. FIG. 7 is a cross-sectional view taken along line VII-VII′ of FIG. 6.

The optical member of FIGS. 6 and 7 is different from that shown in FIGS. 1 and 2, in that a plurality of reflective members cover at least two side surfaces of the light guide plate.

More specifically, referring to FIGS. 6 and 7, the optical member 100_1 may include a light guide plate 10 and a reflective member 50_1 covering each side surface of the light guide plate 10. The reflective member 50_1 may include a first reflective member 50A, a second reflective member 50B, and a third reflective member 50C. The first reflective member 50A may cover a light facing surface 10s3 (see FIG. 1) of the light guide plate 10. The second reflective member 50B and the third reflective member 50C may cover side surfaces 10s2 and 10s4 (see FIG. 1) connected to the light facing surface 10s3 and the inclined surfaces 10r2a, 10r2b, 10r4a, and 10r4b of the light guide plate 10. More particularly, the first to third reflective members 50A, 50B, and 50C may be disposed to cover the side surfaces 10s2, 10s3, and 10s4 except for the light incidence surface 10s1. Since the first reflective member 50A is substantially the same as or similar to that described above with reference to FIGS. 1 and 2, detailed descriptions thereof will be omitted.

The second reflective member 50B may include a second side facing portion 50sB covering one side surface 10s2 of the light guide plate 10, a third folded portion 50raB extending to an upper side of the second side facing portion 50sB to cover the inclined surface 10r2a, and a fourth folded portion 50rbB extending to a lower side of the second side facing portion 50sB to cover the inclined surface 10r2b.

The third reflective member 50C may include a third side facing surface 50sC covering the other side surface 10s4 facing the one side surface 10s2 of the light guide plate 10, a fifth folded portion 50raC extending to an upper side of the third side facing portion 50sC to cover the inclined surface 10r4a, and a sixth folded portion 50rbC extending to a lower side of the third side facing portion 50sC to cover the inclined surface 10r4b.

Since a structure of the first to third reflective members 50A, 50B, and 50C is substantially the same as or similar to the reflective member 50 described in FIGS. 4 and 5, detailed descriptions thereof will be omitted.

The first to third reflective members 50A, 50B, and 50C may not overlap each other at the boundary of each of side surfaces 10s2, 10s3, and 10s4, but in some exemplary embodiments, the first to third reflective members 50A, 50B, and 50C may at least partially overlap each other at the boundary of each of side surfaces 10s2, 10s3, and 10s4.

Light incident through the light incidence surface 10s1 may leak through the side surfaces 10s2 and 10s4 connected to the light facing surface 10s3 as well as the light facing surface 10s3. However, the second and third reflective members 50B and 50C covering the side surfaces 10s2 and 10s4 connected to the light surface 10s3 according to the illustrated exemplary embodiment may prevent incident light from leaking.

The second reflective member 50B and the third reflective member 50C may be attached by the same heat pressing apparatus as that applied to the first reflective member 50A, but in some exemplary embodiments, they may be attached using a separate heat pressing apparatus. After the first reflective member 50A is first attached, the second reflective member 50B and the third reflective member 50C may be attached, but an order of attachment of the reflective members are not particularly limited. For example, in some exemplary embodiment, the first reflective member 50A, the second reflective member 50B, and the third reflective member 50C may be simultaneously attached to the light guide plate 10.

FIGS. 6 and 7 show that the first reflective member 50A, the second reflective member 50B, and the third reflective member 50C cover three side surfaces 10s2, 10s3, and 10s4 except for the light incident surface of the light guide plate, but the inventive concepts are not limited thereto. For example, in some exemplary embodiments, the reflective member 50_1 may cover the light facing surface 10s3 of the light guide plate 10, and may cover either a right-side surface 10s2 or a left-side surface 10s4 of the light guide plate 10.

In addition, the light guide plate 10 is shown as including three side surfaces other than the light incidence surface, but the inventive concepts are not limited thereto. For example, when the light guide plate 10 includes four or more side surfaces other than the light incidence surface, a reflective member for covering the side surfaces may be further provided. As such, the reflective member 50_1 may cover at least two side surfaces of a plurality of side surfaces of a polygon shaped light guide plate, which includes four or more side surfaces other than the light incidence surface 10s2.

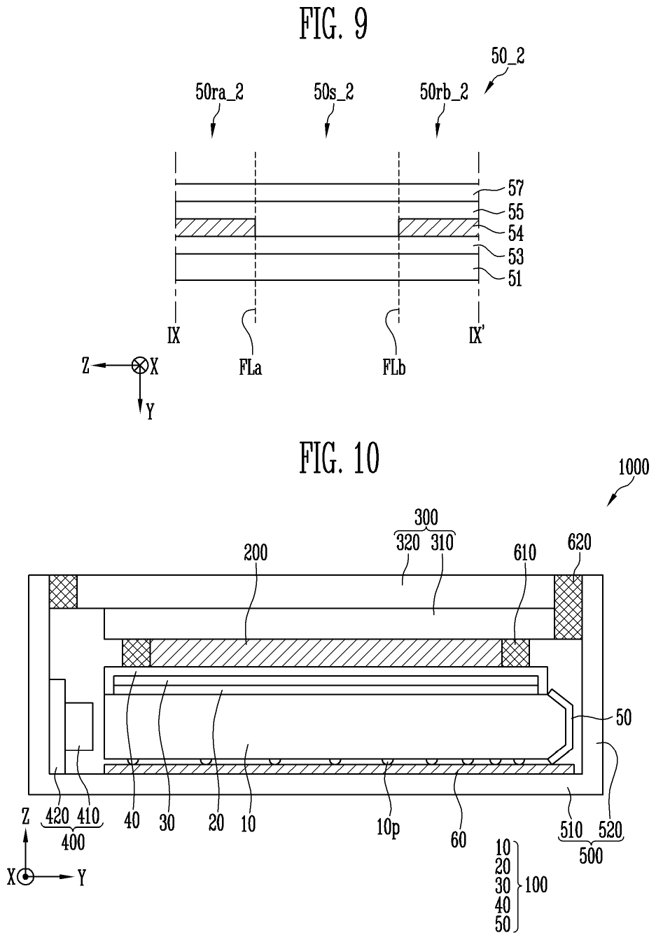

FIG. 8 is a plan view of a reflective member according to another exemplary embodiment. FIG. 9 is a cross-sectional view taken along line IX-IX′ of FIG. 8.

A reflective member 50_2 of FIGS. 8 and 9 according to the illustrated exemplary embodiment is different from the reflective member 50 shown in FIGS. 4 and 5, in that the reflective member 50_2 further includes a light absorption layer 54. Since other structures of the reflective member 50_2 are substantially the same as or similar to the reflective member 50 shown in FIGS. 4 and 5, repeated descriptions thereof will be omitted. The reflective member 50_2 shown in FIGS. 8 and 9 may be attached to the light facing surface of the light guide plate 10, such as the reflective member 50 shown in FIGS. 1 and 2.

Referring to FIGS. 8 and 9 together with FIGS. 1 and 2, a side facing surface 50s_2 of the reflective member 50_2 may include a reflective surface to reflect light, and a first folded portion 50ra_2 and a second folded portion 50rb_2 may include the light absorption layer 54 to absorb light. Accordingly, the reflective member 50_2 may be attached to the side surface 10s3 and the inclined surfaces 10ra and 10rb of the light guide plate 10 to prevent light incident into the light guide plate 10 from leaking.

More specifically, the light absorption layer 54 may be disposed on the reflective layer 53, and may be disposed between the reflective layer 53 and the protective layer 55. The reflective member 50_2 may be divided into a region formed with the light absorption layer 54 is formed, and a region not overlapping with the light absorption layer 54. In an exemplary embodiment, the regions formed with the light absorption layer 54 may be the first folded portion 50ra_2 and the second folded portion 50rb_2, and the region not overlapping the light absorption layer 54 may be a side facing portion 50s_2. The region formed with the light absorption layer 54 may be a region for absorbing light of all incident visible wavelength bands, and the region not overlapping the light absorption layer 54 may be a region for reflecting light of all incident visible wavelength bands. The reflective member 50_2 may absorb leaked light by using the light absorption layer 54 disposed on the first folded portion 50ra_2 and the second folded portion 50rb_2 to more effectively prevent light leakage at the edge of the display device.

In an exemplary embodiment, the light absorption layer 54 may include a light absorption material. The light absorption material is not particularly limited as long as it absorbs light. For example, the light absorption layer 54 may include light absorption materials, such as black pigments, dyes, or the like to absorb light in all visible wavelength bands. The light absorption layer 54 may be directly coated on the reflective layer 53 or may be attached through a separate adhesive layer.

The light absorption layer 54 according to an exemplary embodiment may be disposed to correspond to an area of the first folded portion 50ra_2 and the second folded portion 50rb_2, and may not be disposed in the side facing portion 50s_2 as shown in FIGS. 8 and 9. More particularly a planar area of the light absorption layer 54 may be substantially the same as areas of the first folded portion 50ra_2 and the second folded portion 50rb_2.

The structure of the light absorption layer 54 is not limited that shown in FIGS. 8 and 9. In another exemplary embodiment, the area of the light absorption layer 54 may be larger or smaller than the area of the first folded portion 50ra_2 and the second folded portion 50rb_2. In addition, the light absorption layer 54 may be disposed overall in the first folded portion 50ra_2 and the second folded portion 50rb_2, but it may be disposed in a pattern.

In the first folded portion 50ra_2 and the second folded portion 50rb_2, the reflective layer 53 and the light absorption layer 54 may overlap each other, but in another exemplary embodiments, the reflective layer 53 may be formed only on the side facing surface portion 50s_2 without being formed in the first folded portion 50ra_2 and the second folded portion 50rb_2. In this case, the reflective layer 53 and the light absorption layer 54 may not overlap each other in the thickness direction of the reflective member 50_2.

The protective layer 55 may be formed to cover the reflective layer 53 and the light absorption layer 54 to prevent a penetration of moisture and oxygen. The upper surface of the protective layer 55 may be formed generally flat, but when a protective layer is formed to have a substantially uniform thickness along surfaces of the reflective layer 53 and the light absorbing layer 54, a step may be formed at the upper surface of the protective layer 55.

In an exemplary embodiment, the side facing portion 50s_2 of the reflective member 50_2 may include the reflective layer 53 to reflect incident light toward the light facing side 10s3 of the light guide plate 10, and the first folded portion 50ra_2 and second folded portion 50rb_2 of the reflective member 50_2 may include the light absorption layer 54 to absorb incident light toward the first inclined surface 10ra and the second inclined surface 10rb of the light guide plate 10.

FIG. 10 is a cross-sectional view of a display device according to an exemplary embodiment. A display device 1000 of FIG. 10 may include the optical member 100 described in FIGS. 1 and 2. Although the display device 1000 according to the illustrated exemplary embodiment will be described as including the optical member 100 of FIGS. 1 and 2, the inventive concepts are not limited thereto, and in some exemplary embodiments, the display device 1000 may include the optical member according other exemplary embodiments described above.

Referring to FIG. 10, the display device 1000 includes a light source 400, an optical member 100 disposed on an emission path of the light source 400, and a display panel 300 disposed on the optical member 100.

The light source 400 is disposed on one side of the optical member 100. The light source 400 may be disposed adjacent to the light incidence surface 10s1 of the light guide plate 10 of the optical member 100. The light source 400 may include a plurality of point light sources or line light sources. As described above, the point light source may be a light emitting diode (LED) light source 410. A plurality of LED light sources 410 may be mounted on a printed circuit board 420. The LED light source 410 may emit blue light.

In an exemplary embodiment, the LED light source 410 is a top light emitting LED that emits light to the upper surface as shown in FIG. 10. In this case, the printed circuit board 420 may be disposed on a sidewall 520 of a housing 500. In another exemplary embodiment, the LED light source may be a side light emitting LED that emits light to a side surface. In this case, a printed circuit board may be disposed on a lower surface 510 of the housing 500.

The blue light emitted from the LED light source 410 is incident on the light guide plate 10 of the optical member 100. The light guide plate 10 of the optical member 100 guides light and emits the light through the upper surface or the lower surface of the light guide plate 10. The wavelength conversion layer 30 of the optical member 100 converts a portion of light having a blue wavelength incident from the light guide plate 10 into another wavelength, for example, light of a red wavelength and a green wavelength. The converted light of the red wavelength and green wavelength are emitted to the upper side together with a portion of light having unconverted blue wavelength and provided to the display panel 300.

The display device 1000 may further include a reflective sheet 60 disposed on the lower side of the optical member 100. The reflective sheet 60 may include a reflective film or a reflective coating layer. The reflective sheet 60 reflects light emitted to the lower surface of the light guide plate 10 of the optical member 100 back to the inside of the light guide plate 10.

The display panel 300 is disposed on the optical member 100. The display panel 300 receives light from the optical member 100 to display a screen. Examples of a light-receiving display panel that displays light on the screen may be a liquid crystal panel, an electrophoresis panel, and the like. Hereinafter, the display panel will be described with reference to a liquid crystal panel, but various other light-receiving display panels may be applied without being limited thereto.

The display panel 300 may include a first substrate 310, a second substrate 320 facing the first substrate 310, and a liquid crystal layer disposed between the first substrate 310 and the second substrate 320. The first substrate 310 and the second substrate 320 overlap each other. In an exemplary embodiment, one substrate may be larger than the other substrate to be further protruded outward. For example, the second substrate 320 disposed on the first substrate 310 may be larger than the first substrate 310, and the second substrate 320 is protruded from a side surface in which the light source 400 may be disposed. A protruded region of the second substrate 320 may provide spaces for mounting a driving chip or an external circuit board thereon. In some exemplary embodiments, the first substrate 310 under the second substrate 320 may be larger than the second substrate 320 to protrude outward. A region overlapping the first substrate 310 and the second substrate 320 except for the protruded region in the display panel 300 may be generally aligned at the side surface 10s of the light guide plate 10 of the optical member 100.

The optical member 100 may be coupled to the display panel 300 through a module coupling member 610. The module coupling member 610 may be formed in a quadrangle frame shape in a plan view. The module coupling member 610 may be disposed at the edge of each of the display panel 300 and the optical member 100.

In an exemplary embodiment, a lower surface of the module coupling member 610 between modules is disposed on an upper surface of the passivation layer 40 of the optical member 100. The lower surface of the module coupling member 610 may overlap only the upper surface of the wavelength conversion layer 30 and may not overlap the side surface of the wavelength conversion layer 30 on the passivation layer 40.

The module coupling member 610 may include polymer resin, an adhesive tape, or the like.

In some exemplary embodiments, the module coupling member 610 may further function as a light transmission blocking pattern. For example, the module coupling member 610 may include a light absorption material, such as black pigment, dye, and the like, or may include a reflective material, thereby blocking light transmission.

The display device 1000 may further include a housing 500. The housing 500 includes an open one side surface, a bottom surface 510, and sidewalls 520 connected with the bottom surface 510. A light source 400, a combination of the optical member 100 and the display panel 300, and a reflective sheet 60 may be accommodated in a space defined by the bottom surface 510 and the sidewall 520. The light source 400, the reflective sheet 60, and the combination of the optical member 100 and the display panel 300 are disposed on the bottom surface 510 of the housing 500. A height of the sidewall 520 of the housing 500 may be substantially the same as a height of the combination of the optical member 100 and the display panel 300 inside the housing 500. The display panel 300 is disposed adjacent to an upper portion of the sidewall of the housing 500, and the display panel 300 and the housing 500 may be coupled to each other by a housing coupling member 620. The housing coupling member 620 may be formed in a quadrangle frame shape in a plan view. The housing coupling member 620 may include polymer resin, an adhesive tape, or the like.

The display device 1000 may further include at least one optical film 200. One or a plurality of optical films 200 may be accommodated in a space surrounded by the module coupling member 610 between the optical member 100 and the display panel 300. A side surface of one or a plurality of the optical film 200 may be contacted with an inside surface of the module coupling member 610 to be attached thereto. Although FIG. 10 shows that the optical film 200 and the optical member 100 are separated from each other, and the optical film 200 and the display panel 300 are separated from each other, however, in some exemplary embodiments, spaces between the optical member 100, the optical film 200, and/or the display panel 300 may be omitted.

The optical film 200 may be at least one selected from a prism film, a diffusion film, a micro lens film, a lenticular film, a polarizing film, a reflective polarizing film, a retardation film, or the like. The display device 1000 may include a plurality of optical films 200 of the same or different types. When a plurality of optical films 200 are applied, each of the optical films 200 may be disposed to overlap with each other, and each side surface thereof may be in contact with and attached to an inner surface of the module coupling member 610. The optical films 200 may be spaced apart from each other, and an air layer may be disposed therebetween.

FIG. 11 is a flowchart illustrating a manufacturing method of an optical member according to an exemplary embodiment. FIGS. 12 to 14 are schematic cross-sectional views sequentially illustrating the manufacturing method of an optical member according to an exemplary embodiment.

FIGS. 12 to 14 illustrate a manufacturing method of the optical member shown in FIGS. 1 and 2. As such, the same reference numeral is assigned to the same configuration, and a configuration having the same reference numeral is substantially the same as or similar to that described above, and thus, repeated descriptions thereof will be omitted. Hereinafter, referring to FIGS. 11 to 14, a manufacturing method of a optical member according to an exemplary embodiment will be described in detail.

Referring to FIGS. 11 to 14, a manufacturing method of an optical member according to an exemplary embodiment includes preparing a light guide plate 10 having an inclined surface (S101), disposing a reflective member 50 (S103), preparing a heat pressing apparatus 700 (S105), attaching the reflective member 50 to the light guide plate 10 by using a heat pressing apparatus 700 (S107), and separating the heat pressing apparatus 700 from the light guide plate 10 (S109).

First, the light guide plate 10 may be prepared to be fixed by using a separate fixing apparatus so that the reflective member 50 may be attached to the light guide plate 10.

The light guide plate 10 may include inclined surfaces 10ra and 10rb as shown in FIG. 12. A first inclined surface 10ra may be formed between the upper surface 10a and the side surface 10s of the light guide plate 10, and a second inclined surface 10rb may be formed between the lower surface 10b and the side surface 10s of the light guide plate 10.

The inclined surfaces 10ra and 10rb of the light guide plate 10 may be formed by, for example, edge grinding an edge where the upper surface 10a and the side surface 10s meet and an edge where the lower surface 10b and the side surface 10s meet through a grinding apparatus from a structure in which one side surface 10s of the light guide plate 10 is in perpendicular contact with the upper surface 10a and the lower surface 10b. The inclined surfaces 10ra and 10rb may mitigate the sharpness of the edges of the light guide plate 10, thereby preventing damage caused by external impacts.

The light guide plate 10 may expose the side surface 10s and the inclined surfaces 10ra and 10rb to provide a space for attaching the reflective member 50.

A reflective member 50 including the reflective layer 53 (see FIG. 5) may be prepared and disposed by aligning the reflective member 50 to face the side surface 10s of the light guide plate 10.

The reflective member 50 may include a side facing portion 50s facing the side surface 10s, a first folded surface 50ra extending from the side facing portion 50s to one side, and a second folded surface 50rb extending from the side facing portion 50s to the other side as shown in FIGS. 5 and 12.

The first folded line FLa and the second folded line FLb may be imaginary lines separating the side facing portion 50s and the folded surfaces 50ra and 50rb. More specifically, the first folded surface 50ra and the side facing portion 50s are separated by the first folded line FLa, and the second folded surface 50rb and the side facing portion 50s are separated by the second folded line FLb. The first folded line FLa and the second folded line FLb may generally coincide with a boundary between the side surface 10s and the inclined surfaces 10ra and 10rbs of the light guide plate 10 in the thickness direction of the reflective member 50.

The reflective member 50 may include an adhesive layer for being attached to the light guide plate 10. The adhesive layer may be disposed at the outermost of the reflective member 50 to contact the light guide plate 10. More particularly, one side surface of the reflective member 50 facing the side surface 10s of the light guide plate 10 may be one side surface of the adhesive layer.

In an exemplary embodiment, the reflective member 50 may extend continuously and be rolled on a roller-shaped reel. More specifically, the reflective member 50 may be rolled on a first roll, and one end of the reflective member 50 may be connected to a second roll. The first roll and the second roll may be rotated in the same direction so that the reflective member 50 may be disposed on the side surface 10s of the light guide plate 10.

In another exemplary embodiment, the reflective member 50 may be individually cut to be provided. For example, the reflective member 50 may be individually cut, and one end and the other end of the reflective members 50 may be fixed through a separate apparatus so that the side facing portions 50s align with the side surface 10s of the light guide plate 10.

The first folded line FLa, which is a boundary between the side facing portion 50s of the reflective member 50 and the first folded portion 50ra, may be aligned horizontally with a boundary between the side surface 10s of the light guide plate 10 and the first inclined surface 10ra, and the second folded line FLb, which is a boundary between the side surface 10s of the light guide plate 10 and the second inclined surface 10rb, may be aligned horizontally with a boundary between the side surface 10s of the light guide plate 10 and the second inclined surface 10rb.

Then, the heat pressing apparatus 700 may be provided on the reflective member 50 to attach the reflective member 50 to the side surface 10s of the light guide plate 10.

As described above, the side facing portion 50s of the reflective member 50, which are provided continuously or separately, may be aligned to correspond to the side surface 10s of the light guide plate 10, and the heat pressing apparatus 700 may be aligned on the light guide plate 10 and the reflective member 50 horizontally.

More specifically, the heat pressing apparatus 700 may include a side facing surface heat pressing portion 700s, and an inclined surface heat pressing portion 700ra and 700rb.

The side facing surface heat pressing portion 700s may correspond to the side surface 10s of the light guide plate 10 and the side facing portion 50s of the reflective member 50. More particularly, a shape and area of the side facing surface heat pressing apparatus 700s may be substantially the same as the side surface 10s of the light guide plate 10.

The inclined surface heat press portions 700ra and 700rb may include a first inclined surface heat pressing portion 700ra and a second inclined surface heat pressing portion 700rb. The first inclined surface heat pressing portion 700ra may correspond to the first inclined surface 10ra of the light guide plate 10 and the first folded portion 50ra of the reflective member 50. The second inclined surface heat pressing portion 700rb may correspond to the second inclined surface 10rb of the light guide plate 10 and the second folded portion 50rb of the reflective member 50. More particularly, a shape and area of the first inclined surface heat pressing portion 700r and the second inclined surface heat pressing portion 700rb may be substantially the same as a shape and area of the first inclined surface 10rra and the second inclined surface 10rb of the light guide plate 10.

However, the inventive concepts are not limited thereto. For example, in some exemplary embodiments, the area of the first inclined surface heat pressing portion 700ra and the second inclined surface heat pressing portion 700rb may be larger than the area of the first inclined surface 10ra and second inclined surface 10rb. In this case, although the area of the first inclined surface heat pressing portion 700ra and second inclined surface heat pressing portion 700rb is larger than the area of the first inclined surface 10ra and the second inclined surface 10rb, the heat pressing apparatus 700 may contact the reflective member 50 only in the region corresponding to the first inclined surface 10ra and the second inclined surface 10rb of the light guide plate 10 of the first inclined surface heat pressing portion 700ra and the second inclined surface heat pressing portion 700rb, so that the reflective member 50 may be properly attached to the light guide plate 10.

In addition, an acute angle θ700a formed by the side facing surface heat pressing portion 700s and the first inclined surface heat pressing portion 700ra may be substantially the same as an acute angle θ10a formed by the side surface 10s and the first inclined surface 10ra of the light guide plate 10, and an acute angle θ700b formed by the side facing surface heat pressing portion 700s and the second inclined surface heat pressing portion 700rb may be substantially the same as an acute angle θ10b formed by the side surface 10s and the second inclined surface 10rb of the light guide plate 10.

The heat pressing apparatus 700 may be disposed so that the side facing surface heat pressing portions 700s may be aligned to correspond to the side surface 10s of the light guide plate 10. For example, a boundary between the side surface 10s and the first inclined surface 10ra of the light guide plate 10 may be aligned horizontally with a boundary between the side facing surface heat pressing portion 700s and the first inclined surface heat pressing portion 700ra of the heat pressing apparatus 700, and a boundary between the side surface 10s and the second inclined surface 20ra of the light guide plate 10 may be aligned horizontally with a boundary between the side facing surface heat pressing portion 700s and the second inclined surface heat pressing portion 700rb of the heat pressing apparatus 700.

The heat pressing apparatus 700 may then be used to attach the reflective member 50 to the light guide plate 10 through a heat pressing process.

In the step of preparing the heat pressing apparatus 700 on the reflective member 50, the heat pressing apparatus 700 may be heated to a predetermined temperature. A temperature at which the heat pressing apparatus 700 is heated may be, for example, about 30° C. to about 50° C.

When the heat pressing apparatus 700 is heated to a temperature lower than about 30° C., the reflective member 50 may not adhere well to the light guide plate 10, in other words, an adhesion of the reflective member 50 may not be sufficient. Therefore, the heat pressing apparatus 700 may be heated to a temperature of at least about 30° C. or more.

In addition, when the heat pressing apparatus 700 is heated to a temperature higher than about 50° C., the wavelength conversion layer 30 (see FIG. 2) disposed on the light guide plate 10 may be damaged due to the heat of the heat pressing apparatus 700 during the attachment of the reflective member 50. Therefore, the heat pressing apparatus 700 may be heated to a temperature of about 50° C. or less.

As such, when the heat pressing apparatus 700 is heated to a temperature of about 30° C. to about 50° C., the adhesion between the light guide plate 10 and the reflective member 50 may be sufficiently secured and components of the optical member may be not damaged from the heat of the heat pressing apparatus 700.

After heating the heating pressing apparatus 700, the heat pressing apparatus 700 may be moved in the first direction d1 to be brought into close contact with the light guide plate 10. Since the thickness of the reflective member 50 may be very thin, the heat pressing apparatus 700 moved in the first direction d1 may be completely overlapped with the light guide plate 10.

More specifically, the side facing surface heat pressing portion 700s of the heat pressing apparatus 700 may face the side surface 10s of the light guide plate 10 with the side facing portion 50s of the reflective member 50 therebetween. In addition, the first inclined surface heat pressing portion 700ra of the heat pressing apparatus 700 may face the first inclined surface 10ra of the light guide plate 10 with the first folded surface 50ra of the reflective member 50 therebetween, and the second inclined surface the heat pressing portion 700rb may face the second inclined surface 10rb of the light guide plate 10 with the second folded surface 50rb of the reflective member 50 therebetween.

As described above, since the heat pressing apparatus 700 is superimposed on the light guide plate 10, the reflective member 50 may be brought into close contact with the light guide plate 10. More specifically, the side facing portion 50s of the reflective member 50 may be brought into close contact with the side surface 10s of the light guide plate 10, the first folded portion 50ra may be brought into close contact with the first inclined surface 10ra of the light guide plate 10, and the second folded portion 50rb may be brought into close contact with the second inclined surface 10rb of the light guide plate 10.

As shown in FIG. 5, the reflective member 50 may include an adhesive layer 57 at the outermost thereof, and thus, the adhesive layer 57 may have adherence upon heating.

The heat pressing apparatus 700 heated to the predetermined temperature may move to the first direction d1 side and may apply pressure on the reflective member 50 to carry out a heat pressing process.

The reflective member 50 may be heated by the heat pressing apparatus 700, so that the adhesive layer 57 of the reflective member 50 may have adherence. The heat pressing apparatus 700 may continuously apply pressure to the reflective member 50 while the adhesive layer 57 has adherence, and the adhesive layer 57 of the reflective member 50 may be attached to the side surface 10s, the first inclined surface 10ra, and the second inclined surface 10rb of the light guide plate 10.

Since only a region of the reflective member 50 heated and pressed by the heat pressing apparatus 700 may be attached on the light guide plate 10, even if the reflecting member 50 is continuously extended, only the region of the reflective member 50 subjected to the heat pressing process has may be attached on the light guide plate 10. The region of the reflective member 50 subjected to the heat pressing process may be separated from the remaining regions of the reflective member 50 not subjected to the heat processing process, and thus, the remaining regions of reflective member 50 not performed with the heat processing process may be separated from the light guide plate 10 in a subsequent process.

The heat pressing apparatus 700 may then be moved back to the second direction d2 after the heat pressing process is completed.

As described above, the reflective member 50 may be attached to cover the side surface 10s, the first inclined surface 10ra, and the second inclined surface 10rb of the light guide plate 10, and the heat pressing apparatus 700 may be detached from the reflective member 50.

The light guide plate 10 to which the reflective member 50 is attached may be separated from a fixing apparatus, and a new light guide plate 10 to which the reflective member 50 is not attached may be fixed to the fixing apparatus. When the new light guide plate 10 is fixed, a new reflective member 50 may be disposed on the side surface 10s of the light guide plate 10.

After being separated from the reflective member 50, the heat pressing apparatus 700 may maintain a heated state and continue to reciprocate in the first direction d1 and second direction d2 to attach the reflective member 50 onto the newly fixed light guide plate 10. That is, each step S101 to S109 shown in FIG. 11 may be repeated sequentially.

After the heat pressing process, a coating process or a curing process may be additionally carried out as needed. When the coating process or curing process is performed, a reliability of the reflective member 50 attached on the side surface 10s of the light guide plate 10 may be improved.

As described above, when the reflective member 50 is attached using the heat pressing apparatus 700, the reflective member 50 may be precisely attached to the side surface 10s, the first inclined surface 10ra, and the second inclined surface 10rb of the light guide plate 10, thereby improving an adhesion quality. In addition, an attachment process of the reflective member 50 using the heat pressing apparatus 700 may significantly shorten a process time and cost compared with a manual attachment process, and facilitate a mass attachment process.

An optical member according to exemplary embodiments may effectively prevent light incident into a light guide plate from leaking to a light facing portion without being emitted toward the wavelength conversion layer.

In addition, according to a manufacturing method of an optical member according to exemplary embodiments, a reflective member may be attached substantially flat to a side surface of a light guide plate to improve a process reliability.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An optical member comprising:
a light guide plate including an upper surface, a lower surface facing the upper surface, a first side surface disposed between the upper surface and the lower surface, a first inclined surface disposed between the upper surface and the first side surface, and a second inclined surface disposed between the lower surface and the first side surface; and
a first reflective member including a first side portion covering the first side surface, a first folded portion extending from the first side portion to one side thereof and covering the first inclined surface, and a second folded portion extending from the first side portion to the other side thereof and covering the second inclined surface,
wherein the first reflective member includes a reflective layer having at least one curved surface.

2. The optical member of claim 1, wherein:
the first reflective member further includes a substrate layer;
the reflective layer is disposed between the first side surface of the light guide plate and the substrate layer; and
the reflective layer includes at least one of silver (Ag), copper (Cu), gold (Au), and aluminum (Al).

3. The optical member of claim 2, wherein a width of the first side portion of the first reflective member is greater than a width of each of the first folded portion and the second folded portion.

4. The optical member of claim 2, wherein:
an area of the first folded portion is substantially the same as an area of the first inclined surface of the light guide plate; and
an area of the second folded portion is substantially the same as an area of the second inclined surface of the light guide plate.

5. The optical member of claim 4, wherein the first folded portion or the second folded portion further includes a light absorbing layer disposed between the light guide plate and the reflective layer.

6. The optical member of claim 1, further comprising a second reflective member,
wherein:
the light guide plate further includes a second side surface adjacent to the first side surface, a third inclined surface disposed between the upper surface and the second side surface, and a fourth inclined surface disposed between the lower surface and the second side surface; and
the second reflective member includes a second side portion covering the second side surface, a third folded portion extending from the second side portion to one side thereof and covering the third inclined surface, and a fourth folded portion extending from the second side portion to the other side thereof and covering the fourth inclined surface.

7. The optical member of claim 6, further comprising a third reflective member,
wherein:
the light guide plate further includes a third side surface adjacent to the first side surface and opposite to the second side surface, a fifth inclined surface disposed between the upper surface and the third side surface, and a sixth inclined surface disposed between the lower surface and the third side surface; and
the third reflective member includes a third side portion covering the third side surface, a fifth folded portion extending from the third side portion to one side thereof and covering the fifth inclined surface, and a sixth folded portion extending from the third side portion to the other side thereof and covering the sixth inclined surface.

8. A display device comprising:
a light guide plate including an upper surface, a lower surface facing the upper surface, a first side surface disposed between the upper surface and the lower surface, a second side surface facing the first side surface, a first inclined surface disposed between the upper surface and the first side surface, and a second inclined surface disposed between the lower surface and the first side surface;
a light source disposed to face the second side surface of the light guide plate and configured to emit light of a first color;
a reflective member including a first side portion covering the first side surface, and a first folded portion extending from the first side portion to one side thereof and covering the first inclined surface; and
a display panel disposed on the light guide plate,
wherein the reflective member includes a reflective layer having at least one curved surface.

9. The display device of claim 8, further comprising a wavelength conversion layer disposed on the upper surface of the light guide plate,
wherein:
the wavelength conversion layer includes a first wavelength conversion material and a second wavelength conversion material;
the first wavelength conversion material converts light of the first color into light of a second color different from the first color; and
the second wavelength conversion material converts light of the first color into light of a third color different from the first color and the second color.

10. The display device of claim 9, wherein:
the first color is blue, the second color is red, and the third color is green; and
the light guide plate is configured to emit white light toward the display panel.

11. A manufacturing method of an optical member comprising:
preparing a light guide plate including an upper surface, a lower surface facing the upper surface, a side surface disposed between the upper surface and the lower surface, a first inclined surface disposed between the upper surface and the side surface, and a second inclined surface disposed between the lower surface and the side surface;
disposing a reflective member including a reflective layer on one side of the light guide plate; and
attaching the reflective member on the side surface, the first inclined surface, and the second inclined surface of the light guide plate using a heat pressing apparatus.

12. The manufacturing method of claim 11, further comprising forming a wavelength conversion layer including a quantum dot on the upper surface of the light guide plate.

13. The manufacturing method of claim 12, wherein attaching the reflective member includes:
heating the heat pressing apparatus to a first temperature; and
pressing the reflective member using the heat pressing apparatus.

14. The manufacturing method of claim 13, wherein the first temperature is in a range of about 30° C. to about 50° C.

15. The manufacturing method of claim 12, wherein an acute angle formed by the first inclined surface or the second inclined surface with the side surface ranges from about 30 degrees to about 60 degrees.

16. The manufacturing method of claim 15, wherein:
the reflective member includes a side portion, a first folded portion extending from the side portion to one side thereof, and a second folded portion extending from the side portion to the other side thereof; and
the side portion is substantially parallel to the side surface of the light guide plate.

17. The manufacturing method of claim 15, wherein:
the heat pressing apparatus includes a first heat pressing portion, a second heat pressing portion extending from the first heat pressing portion to one side thereof, and a third heat pressing portion extending from the first heat pressing portion to the other side thereof; and
the first heat pressing portion is substantially parallel to the side surface of the light guide plate.

18. The manufacturing method of claim 17, wherein:
an area of the first heat pressing portion is substantially the same as an area of the side surface of the light guide plate;
an area of the second heat pressing portion is substantially the same as or greater than an area of the first inclined surface of the light guide plate; and
an area of the third heat pressing portion is substantially the same as or greater than an area of the second inclined surface of the light guide plate.

19. The manufacturing method of claim 18, wherein:
an acute angle formed by the second heat pressing portion and the first heat pressing portion is substantially the same as an acute angle formed by the side surface of the light guide plate and the first inclined surface; and
an acute angle formed by the third heat pressing portion and the first heat pressing portion is substantially the same as an acute angle formed by the side surface of the light guide plate and the second inclined surface.
